(19) United States
(12) Patent Application Publication
(10) Pub. No.: US 2014/0068569 A1
(43) Pub. Date: Mar. 6, 2014

(54) USER DIRECTED PROFILING

(71) Applicants: Maxim Goldin, Redmond, WA (US); Brian R. Crawford, Seattle, WA (US)

(72) Inventors: Maxim Goldin, Redmond, WA (US); Brian R. Crawford, Seattle, WA (US)

(73) Assignee: MICROSOFT CORPORATION, Redmond, WA (US)

(21) Appl. No.: 13/600,259

(22) Filed: Aug. 31, 2012

(51) Int. Cl. G06F 9/44

(52) U.S. Cl. 717/130

(57) ABSTRACT

A user can control when data sampling takes place, what data is collected and where in the code the data sampling profiler is invoked. By identifying a section of user code to the profiler, the profiler is instructed to dynamically instrument the identified user code executing in a target application process. The instrumentation invokes the profiler before or after or both before and after the identified section of user code is executed. By identifying an entry point of a component or technology external to the user code, the profiler is instructed to dynamically instrument the external component so that data sampling is logged when the user code calls the entry point of the external component. The data sampling process can be monitored and the sampling rate can be dynamically adjusted.

### BACKGROUND

Development of software applications is challenging. Moreover, as more technologies are integrated within software, it can be difficult to get a comprehensive understanding of the application behavior without understanding the internal implementation, ways of communication and impact on performance of all the technologies used by the application.

Traditionally, diagnostic tools are used to inspect the behavior of an application or a specific module of the application. For example, during execution of the application process, profiler tools can be used to collect data for further analysis.

One profiling technique periodically samples a target process. For example, a sample can be taken after a pre-defined number of specific system events have occurred (e.g., a sample is taken after 100,000 non-halted CPU cycles have been performed or after a particular number of cache writes have been made). When the sample is taken, the profiler may interrupt the process execution and collect data regarding the current state of the process. The data collected may include the number of running threads, the number of loaded modules, or any other available data that the profiler has been programmed to collect. After the data is collected and logged, the process typically continues execution. Traditional profilers do not allow a user to specify what information is collected or when data sampling takes place.

### SUMMARY

“When” during the execution of a target process data sampling is performed can be user-controlled. “Where” in the code data sampling of a target process occurs can be user-controlled. A section of code (a function, block, group of instructions, or instruction) in an application where data collection is to take place can be specified by a user. A data element whose access triggers data collection can be specified by a user. Dynamic instrumentation can be used to allow user directed collection of profiling samples at specified places in user code. That is, instrumentation of code loaded into a target process can be performed by a program module to force data collection to occur at a user directed place in the application's user mode code. Application performance can be maintained by dynamic adjustment of user directed sampling frequency (e.g., in tight loops).

Instrumentation of code loaded into a target process can be performed by a program module to force data collection to occur when an entry point of a component, module or technology is called by user mode code.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings:

FIG. 1a illustrates an example of a user directed profiling system 100 in accordance with aspects of the subject matter described herein;

FIG. 1b illustrates another example of a user directed profiling system 101 in accordance with aspects of the subject matter described herein;

FIG. 1c illustrates a more detailed view of a portion 119 of user directed profiling system 101 in accordance with aspects of the subject matter described herein;

FIG. 2a illustrates an example of a method 200 for providing user directed profiling in accordance with aspects of the subject matter disclosed herein;

FIG. 2b illustrates another example of a method 201 for providing user directed profiling in accordance with aspects of the subject matter disclosed herein;

FIG. 3 is a block diagram of an example of a computing environment in accordance with aspects of the subject matter disclosed herein; and

FIG. 4 is a block diagram of an example of an integrated development environment (IDE) in accordance with aspects of the subject matter disclosed herein.

### DETAILED DESCRIPTION

### Overview

Program analysis tools are used by developers to help understand program behavior. Profiling is a type of program analysis that typically measures the usage of memory, storage unit (e.g., disk accesses) or network resources, the execution of particular instructions, the execution of input/output operations, and so on, to help a developer optimize a program. Collection of data can be triggered by hardware interrupts, by code instrumentation, by instruction set simulation, by operating system hooks, or by performance counters. The output of a profiler can be a log: a statistical summary of the observed events, a trace: a stream of recorded events, a real-time view: an analysis of the data as it is produced and collected by the profiler, an ongoing display of interactions between a virtual machine manager and a process and so on.

A profiler can operate by sampling. A sampling profiler can, for example, examine a system program counter or a target program's program counter at regular intervals using operating system interrupts. When the program counter reaches or exceeds a programmed value, sampling data can be collected. The data resulting from sampling can represent a statistical approximation of actual values. Some profilers operate by instrumentation: by adding instructions to the program, where the added instructions cause the profiling information to be collected. Instrumentation alters program execution and thus can cause deterioration in the performance of the program, and can cause inaccurate results. Instrumentation can be manual: performed by the programmer. Instrumentation can be automatically performed by a tool.

However any particular profiler is implemented, users typically have little control over how a profiler operates. Traditionally, a profiler collects a sample after some system event happens. The data that is collected is the data that the profiler is programmed to collect, not necessarily the data the user wants. A software developer may, however, be interested in samples that are taken at a particular place in his code (e.g., when a particular function is called, when a particular data element is accessed or when a particular control flow is evoked, etc.). Although the application behavior depends on the system it runs on, it is often quite difficult, or impossible, to reliably generate a sample-triggering event on demand at a specific place in the code without modifying the program source code itself.

In accordance with aspects of the subject matter described herein, a user can provide a profiler with one or more directives that control where and when profiling occurs in a target application process. The directive(s) can specify where in the code profiling is to take place. The profiler can receive the directive or directives, identify the section of code specified in the directive(s) and can dynamically instrument that section of code in the target application process. When the instrumented code is executed, the code path can be detoured from the un-instrumented, original code path, instead invoking the profiler before, after or both before and after the section of code specified by the directive(s) is executed. The directive(s) can control when the profiling takes place because data sampling occurs when the section of code specified in the directive(s) is invoked. The user directed profiler in accordance with some aspects of the subject matter described herein can monitor the data sampling process and can dynamically adjust data sampling rate. The user directed profiler can receive directives that identify one or more entry points to one or more internal or external modules, components or technologies accessed by user code. The user directed profiler can dynamically instrument the program modules so that when a directive-identified entry point is accessed by the user code, data sampling is performed. More detail is provided below.

### User Directed Profiling

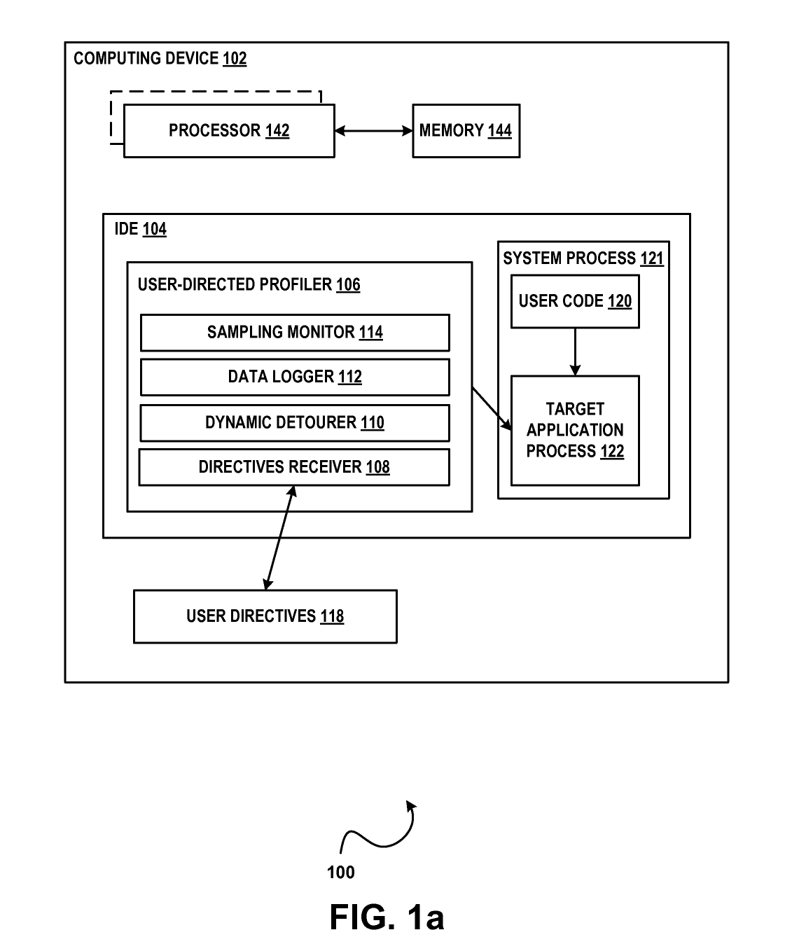

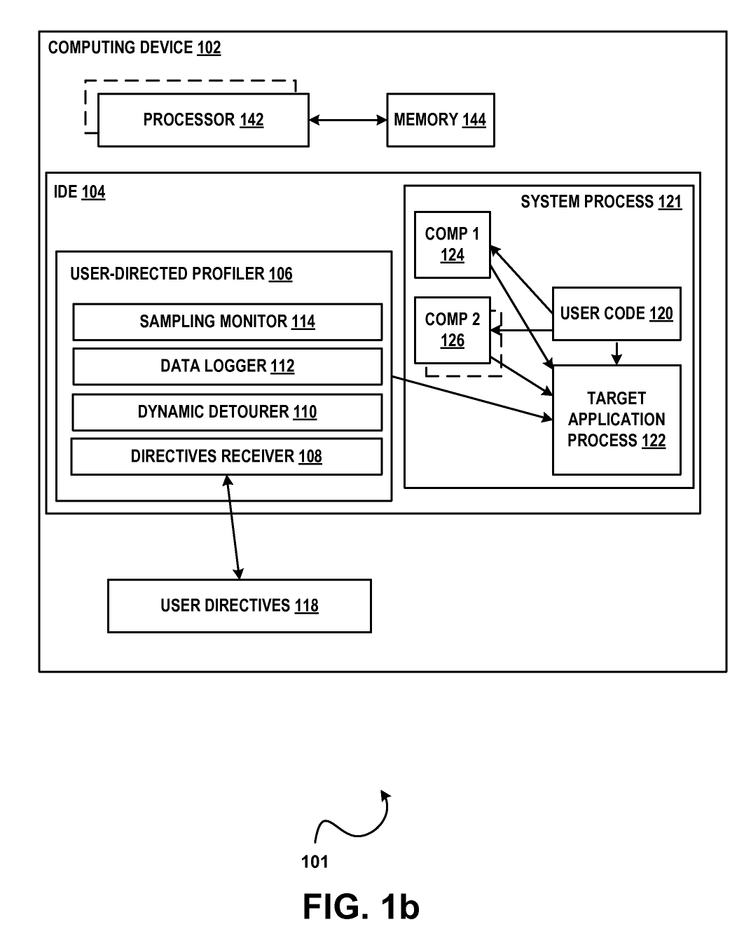

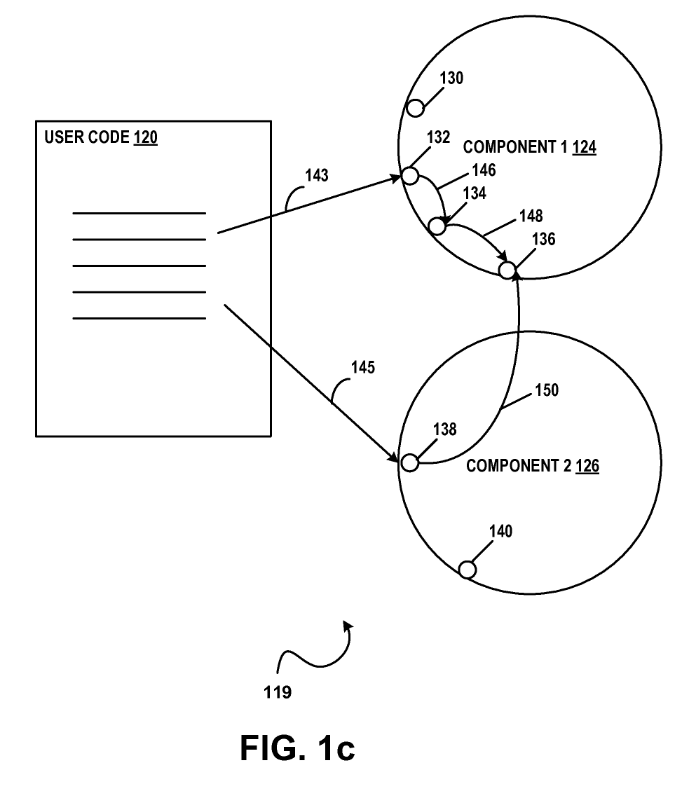

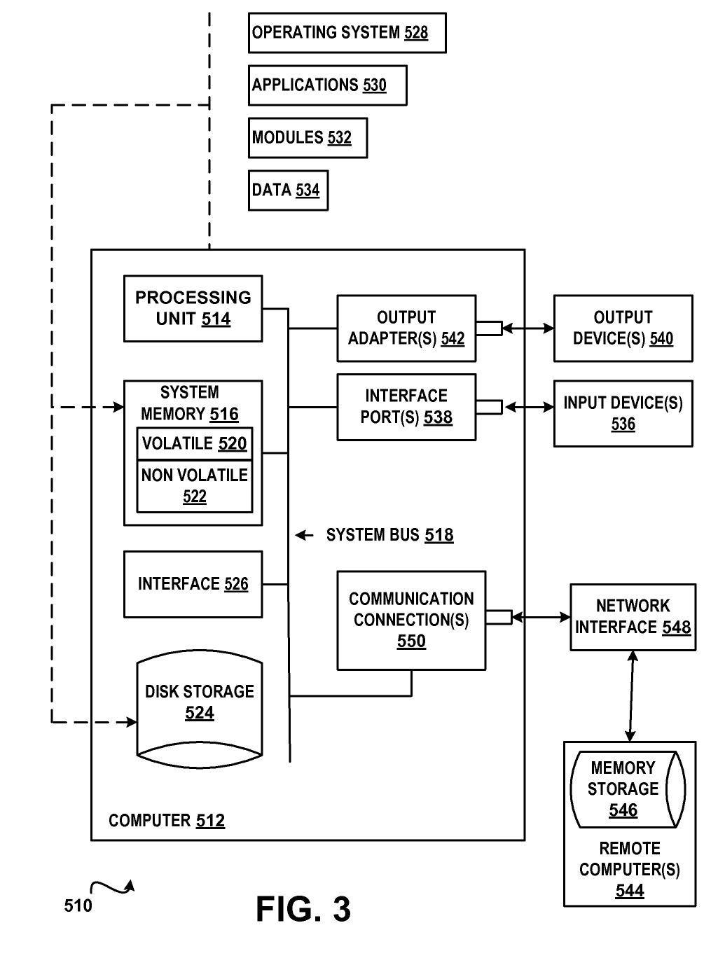

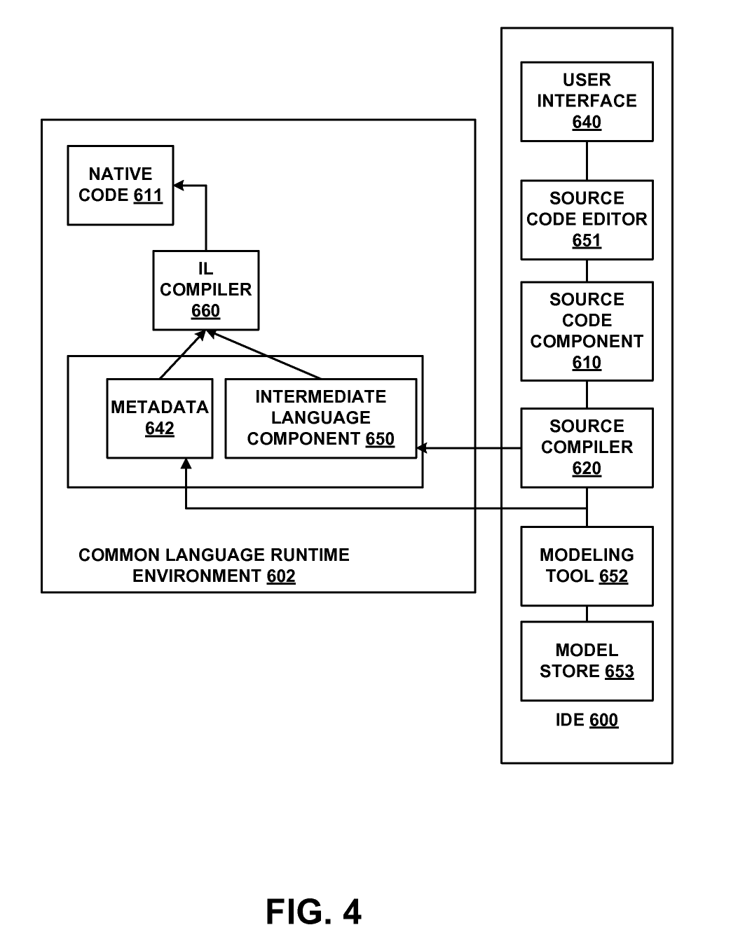

FIG. 1a illustrates a block diagram of an example of a system 100 that performs user directed profiling in accordance with aspects of the subject matter described herein. All or portions of system 100 may reside on one or more computers or computing devices such as the computers described below with respect to FIG. 3. System 100 or portions thereof may be provided as a stand-alone system or as a plug-in or add-in. System 100 may execute in whole or in part on a software development computer such as the software development computer described with respect to FIG. 4. All or portions of system 100 may execute within an integrated development environment (IDE) described more fully with respect to FIG. 4. All or portions of system 100 can execute outside an IDE.

System 100 can include one or more computers or computing devices such as computing device 102. Computing device 102 can include one or more processors such as processor 142, etc., a memory such as memory 144, and one or more modules of a user directed profiler such as user directed profiler 106.

User directed profiler 106 can include or be associated with one or more modules such as: a directive receiving module such as directive receiver 108, a dynamic detouring module such as dynamic detourer 110, and/or a data logger such as data logger 112. User directed profiler 106 may include or be associated with one or more modules such as a sampling monitor module such as sampling monitor 114.

Directive receiver 108 can receive one or more user directives such as user directives 118. User directives 118 can specify where in the code the information to be collected is collected, when the information to be collected is collected and/or what information is to be collected by the user directed profiler 106. User directives 118 can be provided in a configuration file for the user directed profiler 106 or by using an application programming interface (API) implemented by the user directed profiler 106 that acts as a communication channel or by any other way in which directives can be communicated to the user directed profiler 106.

Examples of the content of directives can include identification of a module, component or technology (e.g., Module A), identification of a module, component or technology and an entry point to the module, component or technology (e.g., Module A, entry point 1) and/or a section of user code such as a function (e.g., function foo) or an expression (e.g., an access to data element X) that determines where in the target application process code data sampling will occur and when (e.g., when function foo is invoked, when data element X is accessed, when an entry point in Module A, or when entry point 1 in Module A is called by the user code). That is, for example, in response to receiving user directives, the user directed profiler can be invoked when function foo is called in the program code (the “where”) and can collect information each time the function (e.g., function foo) is called (the “when”), thus enabling the user to control the where and the when of sampling of the user directed profiler. Similarly, a list of functions in a module can be specified in the user directives, in which case the profiler can collect information whenever any function in the list of functions for the specified module is called. Similarly, all functions in a specified module such as Module A can be specified in the user directives, in which case the profiler can collect information whenever any function in the user code calls the module, described more fully below, with respect to FIGS. 1b and 1c. An expression (e.g., a data element access) can be specified so that any time the specified expression is encountered, profiling information can be collected.

The user directed profiler 106 can include or be associated with a dynamic detouring module such as dynamic detourer 110. The term “detouring” as used herein refers to deviating from an original code path of a segment of code (function, block, group of instructions, or instruction) to a different code path which performs an action or action involved in collection of the specified information or performs the specified action before, after or both before and after the original code path of the segment of code is performed. For example, suppose the user directives 118 indicate that current state of certain variables are to be collected whenever the function foo is called in user code such as user code 120 executing in a target application process such as target application process 122 executing in a system process such as system process 121. Detouring can be implemented by invoking the user directed profiler 106 before executing function foo whenever function foo is called in target application process 122. Dynamic detouring refers to automatically and dynamically modifying function foo in the target application process 122 so that the internal behavior of function foo is changed before, after or both before and after it executes. For example, before function foo is executed, a diagnostic function of the user directed profiler 106 can be called that examines the state of the variables. After the information has been collected foo can be executed and then function foo can be changed again.

Detouring can be implemented by creating a remote thread in the target application process and providing the remote thread with names of functions that are to be detoured. Detouring can be implemented by interception of just-in-time (JIT) compilation of a function or functions executing in a virtual environment and modifying the body or bodies of the function(s) being JITed. Detouring can be implemented in an emulator that is miming a function or functions by injecting code before or after segments of code in the emulator. Detouring can be implemented via kernel patching similar to user-mode detouring, where the kernel is patched to invoke the user directed profiler before, after, or both before and after a code segment in the kernel. When a function that has been dynamically detoured is executed, the user directed profiler 106 is given control of the execution of the target application process 122. The user directed profiler 106 may trigger activity that results in collection of stack information and may log the collection of stack information or any other information the user directed profiler 106 can collect. The user directed profiler 106 may be associated with one or more program modules that provide support for the above described operations.

A data logger such as data logger 112 can log the collected information. Logging the collected information can provide the ability to save the collected information so that it can be presented to a user on a display, report or other output. One example of logging technology is ETW (Event Tracing in Windows), although use of any logging mechanism is contemplated. For example, the user directed profiler 106 can initiate an automatic logging session such as an ETW session, anticipating particular events and be configured so that calling stacks are automatically collected and attached to the events. The target application process can be registered as a specific ETW provider, so that execution of a detoured function generates an ETW event of the expected type for the provider. It will be appreciated that the above ETW usage scenario is just an example, and any other logging mechanism could be used instead. Microsoft's ETW functionality has built in capabilities of collecting call stacks for ETW events, however, the same approach and technique could be used in iOS, Android or any other operating system or computing environment.

A sampling monitoring module or modules such as sampling monitor 114 can monitor the sample collection process. A sampling monitoring module can be incorporated within the user directed profiler 106 as shown in FIG. 1a or can be associated with the user directed profiler or can be a standalone component (not shown). A sampling monitoring module such as sampling monitor 114 can measure the time interval between sampling and can adjust the sampling frequency if it determines, based on provided heuristics, that the sampling rate is too high. Suppose, for example, that the user's indicated point of interest occurs on the execution path of a loop that is frequently executed (e.g., in a “tight loop”). Data sampling each time the loop is executed may adversely affect program performance. The sampling monitor may reduce sampling to every second (or third or nth) time through the loop.

As described above, a data logging module or modules such as data logger 112 can log the collected information. A logging module or modules such as data logger 112 can separate user directed sampling data from the default data collected by the user directed profiler, if default data is collected. For example, in accordance with some aspects of the subject matter described herein, sampling can occur at the default time period as in traditional profilers and additionally, as directed by the user. Separation can occur by saving the user directed data to a separate log file or by processing a log file including both traditional and user directed profiling data before the profile result are presented on a display. This feature can be implemented using a flag to tag user directed profiling data so that user directed profiling data can be separated from data that is collected that has not been specifically requested by the user.

While some aspects of user directed sampling involve the ability to invoke data sampling from user code and thus collect data about usage of the user code by any other module in the application, an opposite approach is also contemplated. For example, a user may be interested in understanding where code execution invokes specific modules or technologies such as a database access module, email module, communication module or any other module or technology. A user may not be familiar with the internal details of the technology, yet may be interested in directing the user directed profiler to collect data whenever his code accesses a particular technology. In this case, the user directed profiler can determine or be told the set of modules or portions of modules that belong to a particular technology. With this information, the user directed profiler can detect or be told the API surface for that technology (by detecting all exported APIs—looking in the module's export table, a table of externally available APIs); detecting all public APIs (using metadata about the code to determine accessibility); or reading a provided manifest of APIs. Once the API surface of the technology is understood, the user directed profiler can dynamically detour all relevant code. Each time the detour function is executed, the user directed profiler can collect a desired sample.

FIG. 1b is an example of a system 101 that can provide user directed profiling for user code that invokes one or more other modules, components or technologies in accordance with aspects of the subject matter described herein. A user's user mode code may invoke other models, components or technologies such as a database management system, email system, communication system or any other model, component or technology. The user may want to perform data sampling whenever his code accesses the module, component or technology.

System 101 can include any combination of or all of the elements of system 100 described with respect to FIG. 1a. In addition to the elements of system 100 described with respect to FIG. 1a, FIG. 1b illustrates a system 101 that includes for illustration purposes two components, component 1 124 and component 2 126. It will be understood that although two components are shown in FIG. 1b, any number of components are contemplated for inclusion in system 101. Component 1 124 can be any module, component or technology including but not limited to a database management system, a communication system, an email system and so on. The same is true for component 2 126.

FIG. 1c is a more detailed illustration of a portion 119 of FIG. 1b. FIG. 1c illustrates a portion of user code 120 making a call to an entry point of component 1 124 and another portion of user code 120 making a call to an entry point of component 2 126. Component 1 124 may include one or more entry points. In FIG. 1c, component 1 124 has 4 entry points, entry point 1 130, entry point 2 132, entry point 3 134 and entry point 4 136. Component 2 126 of FIG. 1c includes 2 entry points, entry point 1 138 and entry point 2 140. A portion of user code 120 may make one or more calls such as call 1 143 to an entry point such as entry point 2 132 of component 1 124. A portion of user code 120 may make one or more calls such as call 2 145 to an entry point such as entry point 1 138 of component 2 126. Data can be collected for these calls to components from user code 120. Data regarding a call from user code 120 to entry point 1 130 of component 1 124 can be kept separate from data collected regarding a call from user code 120 to entry point 2 132 of component 1 124. Similarly data regarding a call from user code 120 to entry points in component 2 126 can be kept separate from data collected from calls to entry points in component 1 124.

In addition to calls made to components from user code, components can call each other. For example, component 1 124 may make a call to itself such as call 146 or call 148 or may make a call to another component (this call is not shown). Similarly, component 2 126 may make a call such as call 150 to another component (e.g., component 1 124) or to itself (not shown). Sampling data taken between modules in the same component (for example, call 146 made by component 1 124 between entry point 2 132 and entry point 3 134 or call 148 made by component 1 124 from entry point 3 134 and entry point 4 136) can be filtered out or kept separate from data collected concerning calls made from user code. Similarly sampling data taken between modules in different components (e.g., call 150 made by component 2 126 from entry point 1 138 of component 2 126 to entry point 2 140 of component 2 126 can be filtered out or kept separate. Data sampling that originates from clients outside of the intended evaluation (not shown) can be filtered out or kept separate. One method of implementation of this filtering can be to analyze the call stack, determine the calling function and its location and if the calling function is not in a location in user code, filtering out the sampling data. Sampling data can be analyzed while the program is miming or before the data is reported to the user in order.

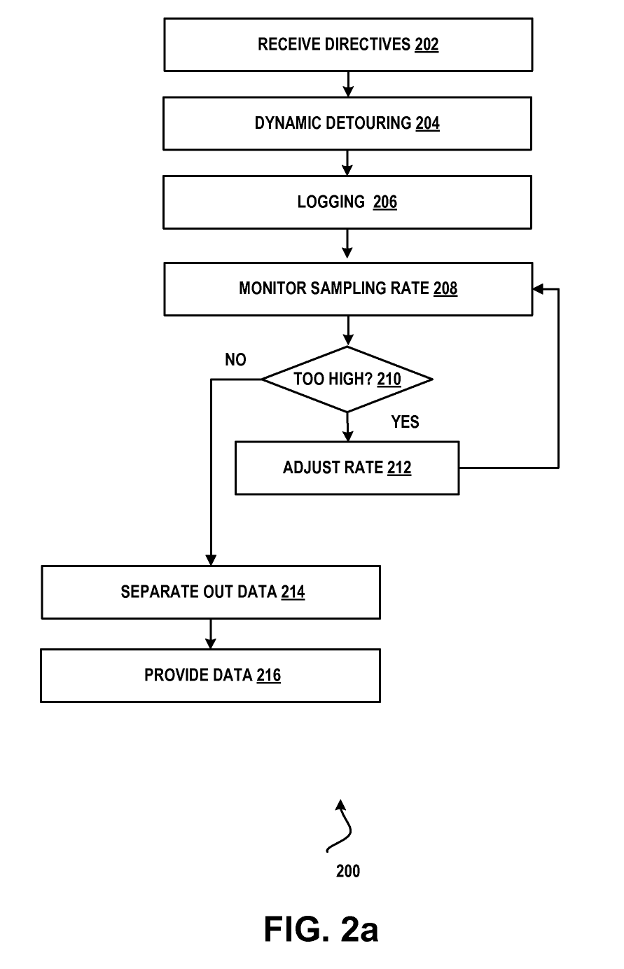

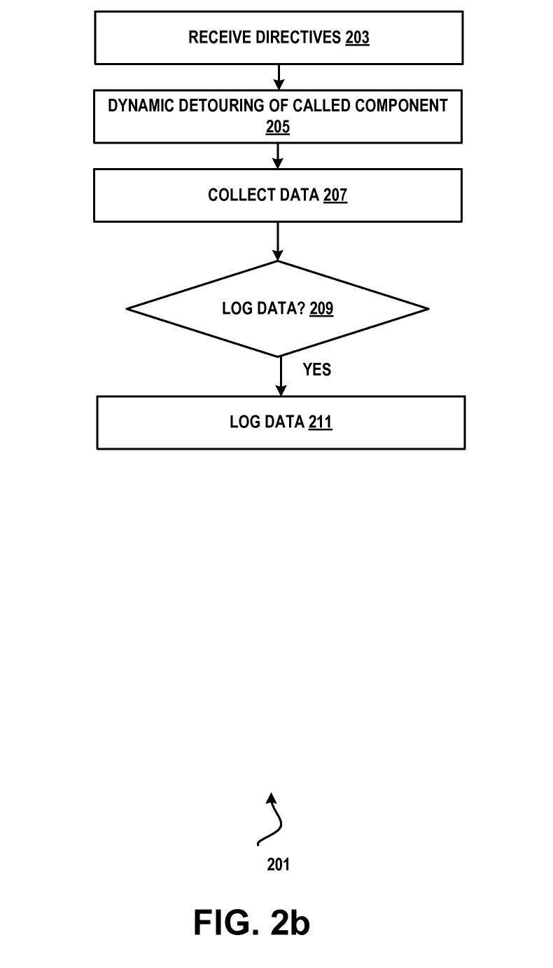

FIG. 2a illustrates a method 200 that can perform user directed profiling in accordance with aspects of the subject matter described herein. The method described in FIG. 2a can be practiced by a system such as but not limited to the one described with respect to FIG. 1a. While method 200 describes a series of operations that are performed in a sequence, it is to be understood that method 200 is not limited by the order of the sequence. For instance, some operations may occur in a different order than that described. In addition, one operation may occur concurrently with another operation. In some instances, not all operations described are performed.

At operation 202 user directives can be received by a user directed profiler. Directives can specify any combination of: where the information to be collected is collected, when the information is to be collected and/or what information is to be collected. User directives can be provided in a configuration file for the profiler or by any other way in which directives can be communicated to the profiler. Examples of directives can include a list of one or more functions (e.g., function foo), a list of one or more code segments, etc. A directive can list one or more modules, components or technologies in which information is to be collected can be specified. In response, the user directed profiler can be invoked in function foo in Model A (the “where”) and can collect information each time the function (e.g., function foo) or code segment is called (the “when”), thus enabling the user to control the sampling of the user directed profiler. Similarly, a list of functions in a model can be specified in the user directives, in which case the profiler can collect information whenever any function in the list of functions for the specified model is called. Similarly, all functions in a specified model such as can be specified in the user directives, in which case the profiler can collect information whenever any function in the model is called. An expression (e.g., accessing a data element) can be specified so that any time the specified expression is encountered, profiling information can be collected.

In response to receiving the directives, whenever the condition is met, (e.g., a specified function is called or a specified expression is encountered in a function, etc.) at operation 204, dynamic detouring of the user function or functions can be triggered. Detouring as used herein refers to deviating from an original code path of a code segment to a different code path which performs an action or action involved in collection of the specified information or performs the specified action. For example, suppose the user directives indicate that current state of certain variables are to be collected before and after the function foo is called. Detouring can be implemented by invoking the user directed profiler before and after executing function foo whenever function foo is called. Dynamic detouring can refer to automatically and dynamically modifying function foo in the target application process so that the internal behavior of function foo is changed before it executes. For example, before function foo is executed, a diagnostic function can be called that examines the state of the variables. After the information has been collected foo can be executed. After foo is executed, the diagnostic function can be called again.

Detouring can be implemented by creating a remote thread in the target application and providing the remote thread with names of function for detouring. Detouring can be implemented by interception of just-in-time compilation of a function or functions executing in a virtual environment and modifying the body or bodies of the function(s). When a function that has been dynamically detoured is executed, the user directed profiler is given control of the execution of the process. The user directed profiler may trigger activity that results in collection of stack information and may log the collection of stack information. The user directed profiler may be associated with one or more program modules that provides support for the above described actions.

At 206 logging of the collected information can occur. Logging the collected information can provide the ability to save the collected information so that it can be presented to a user on a display, report or other output. One example of logging technology is ETW (Event Tracing in Windows), although use of any automatic logging mechanism is contemplated. For example, the user directed profiler can initiate an automatic logging session such as an ETW session, anticipating particular events and be configured so that calling stacks are automatically collected and attached to the events. The target application can be registered as a specific ETW provider, so that execution of a detoured function generates an ETW event of the expected type. It will be appreciated that the above ETW usage scenario is just an example, and any other logging mechanism could be used instead. In Microsoft Corporation's Windows® it may be convenient to use ETW because of its built in capabilities of collecting call stacks for ETW events, however, the same approach and technique could be used in iOS, Android or any other operating system or computing environment.

At optional operation 208, the sample collection process can be monitored. The operations described above can be monitored by one or more program modules such as a sampling monitor associated with the user directed profiler. The sampling monitor can measure the time interval between sampling and can adjust the sampling frequency at operation 212 if it determines at operation 210, based on provided heuristics, that the sampling rate is too high. Suppose, for example, that the user's indicated point of interest occurs on the execution path of a loop that is frequently executed (e.g., in a “tight loop”). Data sampling each time the loop is executed may adversely affect program performance. The sampling monitor may reduce sampling to every second (or third or nth) time through the loop.

At optional operation 214, user directed profiling data can be separated from the traditional data collected by the user directed profiler, if traditional data is collected. For example, in accordance with some aspects of the subject matter described herein, sampling can occur at the default time period as in traditional profilers and additionally, as directed by the user. Separation can occur by saving the user directed data to a separate log file or by processing a log file including both traditional and user directed profiling data before the profile result are presented on a display. This feature can be implemented using a flag to tag user directed profiling data. At operation 216 the information can be provided to the user.

FIG. 2b illustrates a method 201 that can perform user directed profiling in accordance with aspects of the subject matter described herein. The method described in FIG. 2b can be practiced by a system such as but not limited to the one described with respect to FIGS. 1b and 1c. While method 201 describes a series of operations that are performed in a sequence, it is to be understood that method 201 is not limited by the order of the sequence. For instance, some operations may occur in a different order than that described. In addition, one operation may occur concurrently with another operation. In some instances, not all operations described are performed.

At operation 203 user directives can be received by a user directed profiler. Directives can specify where the information to be collected is collected, when the information is to be collected and/or what information is to be collected. User directives can be provided in a configuration file for the profiler or by any other way in which directives can be communicated to the profiler. Examples of directives can include one or more external (to the user code) modules, components or technologies (e.g., entry point 1 of Module A and entry point 6 and 8 of Module B).

A user directive can include a code segment including but not limited to a function in user code, a list of one or more functions or designate all functions which access one or more entry points to the module, component or technology. If a list of a function or functions are not provided, the user directed profiler can dynamically determine which function or functions in the user code access the identified entry points in the identified modules, components or technologies

In response to receiving the directives, whenever the condition is met, (e.g., a function in the user code calls a specified entry point in a specified module) at operation 205, dynamic detouring of the module, component or technology identified by the directives can be triggered. At operation 207 information can be collected. At operation 209, if it is determined that the information is to be logged, the information can be logged at operation 211. At operation 209, it can be determined if the entry point was called by user code or by another entry point of the same or different component. Data collected when one external component calls another external component can be excluded from logging.

### Example of a Suitable Computing Environment

In order to provide context for various aspects of the subject matter disclosed herein, FIG. 3 and the following discussion are intended to provide a brief general description of a suitable computing environment 510 in which various embodiments of the subject matter disclosed herein may be implemented. While the subject matter disclosed herein is described in the general context of computer-executable instructions, such as program modules, executed by one or more computers or other computing devices, those skilled in the art will recognize that portions of the subject matter disclosed herein can also be implemented in combination with other program modules and/or a combination of hardware and software. Generally, program modules include routines, programs, objects, physical artifacts, data structures, etc. that perform particular tasks or implement particular data types. Typically, the functionality of the program modules may be combined or distributed as desired in various embodiments. The computing environment 510 is only one example of a suitable operating environment and is not intended to limit the scope of use or functionality of the subject matter disclosed herein.

With reference to FIG. 3, a computing device in the form of a computer 512 is described. Computer 512 may include at least one processing unit 514, a system memory 516, and a system bus 518. The at least one processing unit 514 can execute instructions that are stored in a memory such as but not limited to system memory 516. The processing unit 514 can be any of various available processors. For example, the processing unit 514 can be a graphics processing unit (GPU). The instructions can be instructions for implementing functionality carried out by one or more components or modules discussed above or instructions for implementing one or more of the methods described above. Dual microprocessors and other multiprocessor architectures also can be employed as the processing unit 514. The computer 512 may be used in a system that supports rendering graphics on a display screen. In another example, at least a portion of the computing device can be used in a system that comprises a graphical processing unit. The system memory 516 may include volatile memory 520 and nonvolatile memory 522. Nonvolatile memory 522 can include read only memory (ROM), programmable ROM (PROM), electrically programmable ROM (EPROM) or flash memory. Volatile memory 520 may include random access memory (RAM) which may act as external cache memory. The system bus 518 couples system physical artifacts including the system memory 516 to the processing unit 514. The system bus 518 can be any of several types including a memory bus, memory controller, peripheral bus, external bus, or local bus and may use any variety of available bus architectures. Computer 512 may include a data store accessible by the processing unit 514 by way of the system bus 518. The data store may include executable instructions, 3D models, materials, textures and so on for graphics rendering.

Computer 512 typically includes a variety of computer readable media such as volatile and nonvolatile media, removable and non-removable media. Computer readable media may be implemented in any method or technology for storage of information such as computer readable instructions, data structures, program modules or other data. Computer readable media include computer-readable storage media (also referred to as computer storage media) and communications media. Computer storage media includes physical (tangible) media, such as but not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices that can store the desired data and which can be accessed by computer 512. Communications media include transitory media such as, but not limited to, communications signals, modulated carrier waves or any other transitory media which can be used to communicate the desired information and which can be accessed by computer 512.

It will be appreciated that FIG. 3 describes software that can act as an intermediary between users and computer resources. This software may include an operating system 528 which can be stored on disk storage 524, and which can allocate resources of the computer 512. Disk storage 524 may be a hard disk drive connected to the system bus 518 through a non-removable memory interface such as interface 526. System applications 530 take advantage of the management of resources by operating system 528 through program modules 532 and program data 534 stored either in system memory 516 or on disk storage 524. It will be appreciated that computers can be implemented with various operating systems or combinations of operating systems.

A user can enter commands or information into the computer 512 through an input device(s) 536. Input devices 536 include but are not limited to a pointing device such as a mouse, trackball, stylus, touch pad, keyboard, microphone, voice recognition and gesture recognition systems and the like. These and other input devices connect to the processing unit 514 through the system bus 518 via interface port(s) 538. An interface port(s) 538 may represent a serial port, parallel port, universal serial bus (USB) and the like. Output devices(s) 540 may use the same type of ports as do the input devices. Output adapter 542 is provided to illustrate that there are some output devices 540 like monitors, speakers and printers that require particular adapters. Output adapters 542 include but are not limited to video and sound cards that provide a connection between the output device 540 and the system bus 518. Other devices and/or systems or devices such as remote computer(s) 544 may provide both input and output capabilities.

Computer 512 can operate in a networked environment using logical connections to one or more remote computers, such as a remote computer(s) 544. The remote computer 544 can be a personal computer, a server, a router, a network PC, a peer device or other common network node, and typically includes many or all of the elements described above relative to the computer 512, although only a memory storage device 546 has been illustrated in FIG. 3. Remote computer(s) 544 can be logically connected via communication connection(s) 550. Network interface 548 encompasses communication networks such as local area networks (LANs) and wide area networks (WANs) but may also include other networks. Communication connection(s) 550 refers to the hardware/software employed to connect the network interface 548 to the bus 518. Communication connection(s) 550 may be internal to or external to computer 512 and include internal and external technologies such as modems (telephone, cable, DSL and wireless) and ISDN adapters, Ethernet cards and so on.

It will be appreciated that the network connections shown are examples only and other means of establishing a communications link between the computers may be used. One of ordinary skill in the art can appreciate that a computer 512 or other client device can be deployed as part of a computer network. In this regard, the subject matter disclosed herein may pertain to any computer system having any number of memory or storage units, and any number of applications and processes occurring across any number of storage units or volumes. Aspects of the subject matter disclosed herein may apply to an environment with server computers and client computers deployed in a network environment, having remote or local storage. Aspects of the subject matter disclosed herein may also apply to a standalone computing device, having programming language functionality, interpretation and execution capabilities.

FIG. 4 illustrates an integrated development environment (IDE) 600 and Common Language Runtime Environment 602. An IDE 600 may allow a user (e.g., developer, programmer, designer, coder, etc.) to design, code, compile, test, run, edit, debug or build a program, set of programs, web sites, web applications, and web services in a computer system. Software programs can include source code (component 610), created in one or more source code languages (e.g., Visual Basic, Visual J#, C++. C#, J#, Java Script, APL, COBOL, Pascal, Eiffel, Haskell, ML, Oberon, Perl, Python, Scheme, Smalltalk and the like). The IDE 600 may provide a native code development environment or may provide a managed code development that runs on a virtual machine or may provide a combination thereof. The IDE 600 may provide a managed code development environment using the Microsoft . NET™ framework. An intermediate language component 650 may be created from the source code component 610 and the native code component 611 using a language specific source compiler 620 using a modeling tool 652 and model store 653 and the native code component 611 (e.g., machine executable instructions) is created from the intermediate language component 650 using the intermediate language compiler 660 (e.g. just-in-time (JIT) compiler), when the application is executed. That is, when an intermediate language (IL) application is executed, it is compiled while being executed into the appropriate machine language for the platform it is being executed on, thereby making code portable across several platforms. Alternatively, in other embodiments, programs may be compiled to native code machine language (not shown) appropriate for its intended platform.

A user can create and/or edit the source code component according to known software programming techniques and the specific logical and syntactical rules associated with a particular source language via a user interface 640 and a source code editor 651 in the IDE 600. Thereafter, the source code component 610 can be compiled via a source compiler 620, whereby an intermediate language representation of the program may be created, such as assembly 630. The assembly 630 may comprise the intermediate language component 650 and metadata 642. Application designs may be able to be validated before deployment.

The various techniques described herein may be implemented in connection with hardware or software or, where appropriate, with a combination of both. Thus, the methods and apparatus described herein, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing aspects of the subject matter disclosed herein. As used herein, the term “machine-readable storage medium” shall be taken to exclude any mechanism that provides (i.e., stores and/or transmits) any form of propagated signals. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-specific programming models aspects, e.g., through the use of a data processing API or the like, may be implemented in a high level procedural or object oriented programming language to communicate with a computer system. However, the program(s) can be implemented in assembly or machine language, if desired. In any case, the language may be a compiled or interpreted language, and combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A system comprising:
at least one processor of a computing device;
a memory of the computing device; and
at least one module loaded into the memory causing the at least one processor to:
receive at least one user directive, the at least one user directive specifying a section of code where profiling of a target application process takes place, the at least one user directive determining when during execution of the target application process, profiling of the target application process takes place.

2. The system of claim 1, further comprising:
at least one module loaded into the memory causing the at least one processor to:
automatically and dynamically instrument a section of code loaded into a target application process to invoke a profiling module.

3. The system of claim 1, further comprising:
at least one module loaded into the memory causing the at least one processor to:
collect data samples when the section of code identified by the at least one user directive is invoked.

4. The system of claim 2, wherein instrumenting the section of code loaded into the target application process comprises detouring code processing from an original code path associated with un-instrumented section of code to a code path that invokes the profiling module.

5. The system of claim 1, wherein the at least one user directive identifies a section of code to be dynamically instrumented, the section of code loaded into the target application process.

6. The system of claim 1, wherein the section of code is user code comprising at least one function, block, group of instructions, or instruction.

7. The system of claim 1, wherein the section of code is a component external to the user code called by the user code.

8. The system of claim 1, wherein the section of code is user code comprising an expression.

9. A method comprising:
receiving at least one user directive by a processor of a computing device, the at least one user directive controlling a location in code in a target application process at which data sampling is performed, the user directive controlling the location at which data sampling is performed by identifying a section of code in the target application process;
in response to invoking the identified section of code, invoking a profiling module one of before, after, or before and after executing the identified section of code, the profiling module sampling data when invoked; and
displaying the collected sampling data.

10. The method of claim 9, further comprising:
dynamically instrumenting the identified section of code in the target application process to invoke the profiling module before, after or both before and after executing the identified section of code.

11. The method of claim 9, further comprising:
separating data sampling conducted in response to receiving the at least one user directive from other data sampling performed by the profiling module and displaying the separated data sampling data on a display device.

12. The method of claim 9, further comprising:
determining that the section of code in the target application process identified in the at least one user directive identifies a component external to user code that calls an entry point specified in the at least one user directive.

13. The method of claim 9, further comprising:
monitoring sampling of the target application process and dynamically adjusting sampling rate of the target application process.

14. The method of claim 9, further comprising:
excluding from logging data sampling occurring in response to calls from a first external component to a second external component.

15. A computer-readable storage medium comprising computer-executable instructions which when executed cause at least one processor of a computing device to:
receive at least one user directive, the at least one user directive specifying a section of code where profiling of a target application process is invoked.

16. The computer-readable storage medium of claim 15, comprising further computer-executable instructions, which when executed cause the at least one processor to:
automatically and dynamically instrument a section of code loaded into a target application process to invoke a profiling module.

17. The computer-readable storage medium of claim 15, comprising further computer-executable instructions, which when executed cause the at least one processor to:
collect data samples when the section of code identified by the at least one user directive is invoked.

18. The computer-readable storage medium of claim 15, comprising further computer-executable instructions, which when executed cause the at least one processor to:
receive the at least one user directive identifying user code comprising a section of code comprising a function, block, group of instructions, or instruction.

19. The computer-readable storage medium of claim 15, comprising further computer-executable instructions, which when executed cause the at least one processor to:
receive the at least one user directive identifying user code comprising an expression.

20. The computer-readable storage medium of claim 15, comprising further computer-executable instructions, which when executed cause the at least one processor to:
receive the at least one user directive identifying a component external to user code, the user code calling the component.
